(19) United States
(12) Patent Application Publication
(10) Pub. No.: US 2009/0290722 A1
(43) Pub. Date: Nov. 26, 2009

(54) AUDIBLE PRODUCT INFORMATION DEVICE

(75) Inventors: Glenn Dorflinger, Mayfield Heights, OH (US); Robert Kral, Cleveland Heights, OH (US); Mark Stephany, Brecksville, OH (US)

Correspondence Address: Rankin, Hill & Clark LLP, 23755 Lorain Road, Suite 200, North Olmsted, OH, 44070, US

(73) Assignee: CUSTOM TALK LLC, Mayfield Heights, OH (US)

(21) Appl. No.: 12/533,232

(22) Filed: Jul. 31, 2009

Related U.S. Application Data
(63) Continuation of application No. 11/734,428, filed on Apr. 12, 2007.
(60) Provisional application No. 60/793,996, filed on Apr. 12, 2006.

(51) Int. Cl. H04B 3/00; G06F 17/00; G08B 25/08

(52) U.S. Cl. 381/77; 700/94; 340/692

(57) ABSTRACT

Another example of an audible product information device for placing proximate and associated consumer product includes a housing and electrical components in the housing configured to operate in a playback mode, a record more, and a standby mode. The electrical components include a controller, a record playback device for storing and playing an audible product information message, a speaker for audibly outputting the audible product information message, battery contact terminals in electrical communication with the record/playback device, an activation switch for starting a playback of the product information message, and a recording switch for starting a recording of the product information message. A method for providing an audible product information message to a consumer is also disclosed.

This application is a continuation of U.S. patent application Ser. No. 11/734,428 filed Apr. 12, 2007, which claims priority to U.S. provisional patent application Ser. No. 60/793,996, filed Apr. 12, 2006, which are incorporated by reference herein in their entirety.

### BACKGROUND

The device and method described herein relates to in-store informational advertising, and more particularly point-of-purchase advertising. It finds particular application in conjunction with shelf-mounted informational message displays related to products displayed in a location proximate to the information message display and will be described with particular reference thereto. It is to be appreciated, however, that the device and method described herein is also amenable to other like applications.

It often times happens that many similar and competing consumer products are displayed by a retailer in proximity to each other and even side by side. This is done for the convenience of the shopper so that the shopper may choose from the widest possible variety of consumer products. Nevertheless, a large number of similar products often leads to confusion for the consumer. In many cases, the consumer may be overwhelmed and resort to seeking out only a brand familiar to the consumer rather than examining the wealth of possibilities. Thus, a consumer may actually be inadvertently restricted to a few choices, defeating the purpose of displaying a wide variety of products.

Although by no means limited to the wine industry, the above-described problem is particularly noticeable in grocery stores and other large retailers where a rich variety of competing brands of different types of wines are displayed side by side for the consumer. This leads to difficulty with respect to consumers finding information about particular wines. Sometimes, an in-store wine consultant is available for consultation, however, this is an expensive and time consuming solution to the problem, and sometimes even the in-store wine consultant does not have a good description of a particular wine.

Most wine producers try to provide essential information about a particular wine in the limited space available on the bottle or package labeling. This can lead to unnecessary handling of the wine bottle and difficulty for the consumer because of the fine print necessitated by the small area available on the labeling and the inconvenient manner in which the information is made available. These problems are also evident with many other products, for example products in the food industry such as liquor, beer, and cheeses as well as other consumer products where it might be desirable to provide the consumer with a bit of information to aid the consumer in making a selection.

Because of the aforementioned problems, retailers and producers have sought a solution for more conveniently informing and educating consumers about a particular product and, just as importantly, calling attention to their product. One solution to these problems is what is commonly referred to as a shelf talker, which is typically a printed card or other sign used in retail stores to call attention to a shelved product. It is commonly attached to the front edge of retail shelves or railings of display cases. To promote wines, many wineries and distributors offer a wide variety of shelf talkers to assist in the marketing of their wines. It has been found that wines that are accompanied by a shelf talker tend to sell more than wines that are not accompanied by a shelf talker. While this solution is commonly used by many retailers for providing informational messages about various retail products including wines, problems remain in the fact that the limited space is available for providing information and the customer is still typically required to read fairly small print which often times is riot provided at convenient eye level for reading.

A shelf talker card ST is shown in FIG. 1. Wine bottles W are placed on a retail shelf R for the consumer's convenience. For the consumer to more quickly identify and understand the specifics of the wine, a shelf talker card ST, which is currently known in the art, is affixed to a label channel C located on a forward edge of the retail shelf R in proximity to the associated wine that the shelf talker card describes.

With continued reference to FIG. 1, the shelf talker card ST associated with the particular wine bottle W is shown as typically including a combination of graphical and textual information such as, for example, a logo and a written description of the associated wine. The previously described problems associated with this known solution are made evident by the constrained space which the shelf talker occupies, thereby limiting the amount of information and available image and font sizes for providing the written description describing the wine.

Retailers and producers have also informed and educated consumers through devices that are displayed adjacent products. U.S. Pat. No. 5,608,449 describes a basic audio only unit that includes a chip that contains digitized audio messages associated with each pushbutton. The patent goes on to state that any change of information requires that the audio message chip be replaced. Such an operation may difficult for a retail salesperson to perform, and it is highly desirable to allow an audio device to be easily reprogrammed with a new audible message so that a single device can be easily used to promote many different products over time. Moreover the patent does not include any discussion regarding this device and the safeguarding of the audio message chip and the battery from tampering.

U.S. Pat. No. 5,032,716 describes an audio message delivery device that includes a housing having a light sensing means located on a rear surface of the housing. The photosensitive surface of the light sensing means is directed towards the interior of the retail shelf. The device is clamped to the shelf so that the bottom portion of the housing, which contains the light sensing means, extends below the bottom of the shelf. Consumers cast a shadow when passing in front of the audio message delivery device and the light sensing means detects this. Since the housing of this device extends below the retail shelf, removing a product from a retail shelf that is below the audio message delivery device can be difficult. Additionally, power is consumer to operate the light sensing means, which shortens the operating life of the battery used to drive the electronics in this device as compared to a device that does not include such a light sensing means.

For the above stated reasons, improved methods and devices for providing product information to consumers is highly desirable.

### SUMMARY

An audible product information device for placing proximate and associated consumer product includes a housing, a recording device, a playback device, a speaker, a battery compartment, an activation switch, and a recording switch. The recording device is found in the housing for storing an audible product information message. The playback device is found in the housing for playing the audible product information message. The battery compartment includes terminals in electrical communication with the recording device and the playback device. The activation switch is for starting a playback of the product information message. The recording switch is for controlling the delivery of power to the recording device.

A method for providing product information to a consumer includes providing an audible product information device that is configured to mount to a retail shelf near a consumer product, receiving an audible product information message into the memory of the audible product information device, sensing operation of the activation switch of the audible product information device, playing the product information message, and shutting down the device after playing the product information message. The device includes a housing, memory in the housing, a control in the housing that is in communication with the memory, an activation switch that is communication with the control, a speaker that is in communication with the control, and a battery in the housing and in electrical communication with the control. When the device is shut down, the power consumption of the audible product information device is less than the self discharge rate of the battery.

Another example of an audible product information device for placing proximate and associated consumer product includes a housing and electrical components in the housing configured to operate in a playback mode, a record mode, and a standby mode. The electrical components include a controller, a record playback device for storing and playing an audible product information message, a speaker for audibly outputting the audible product information message, battery contact terminals in electrical communication with the record/playback device, an activation switch for starting a playback of the product information message, and a recording switch for starting a recording of the product information message. The device is configured such that while in the standby mode, the electrical components of the device consume less power than a typical self discharge rate of a typical AA alkaline battery.

### BRIEF DESCRIPTION OF THE DRAWINGS

FIG. 1 is a view of a prior art shelf talker card placed adjacent a bottle of wine.

FIG. 2 is a front view of the audio product information device placed adjacent a bottle of wine.

FIG. 3 is a rear elevation view of the audio product information device shown in FIG. 2.

FIG. 4 is a front perspective view of the device shown in FIG. 2.

FIG. 5 is a rear perspective view of the device shown in FIG. 2.

FIG. 6 is a schematic depiction of the electrical components of the audible product information device shown in FIG. 2.

FIG. 7 is an alternative embodiment of the electrical components of an audible product information device which can look the same or very similar to the device shown in FIG. 2.

FIG. 8 shows a method of programming the audible product information device and utilizing it for playback in a retail location.

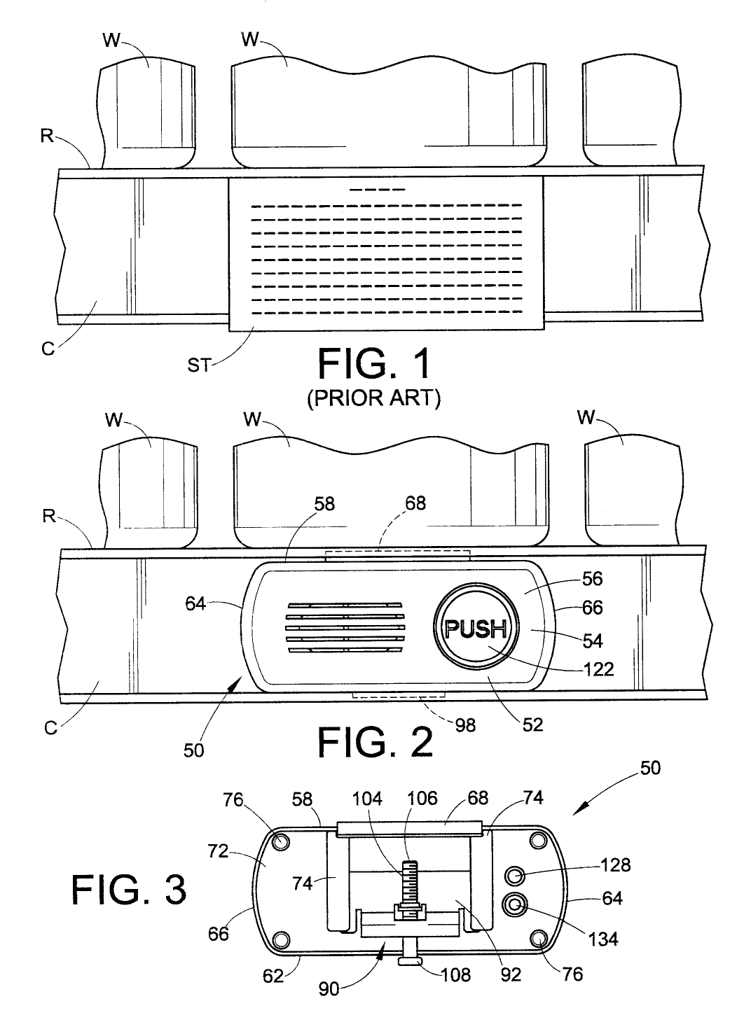

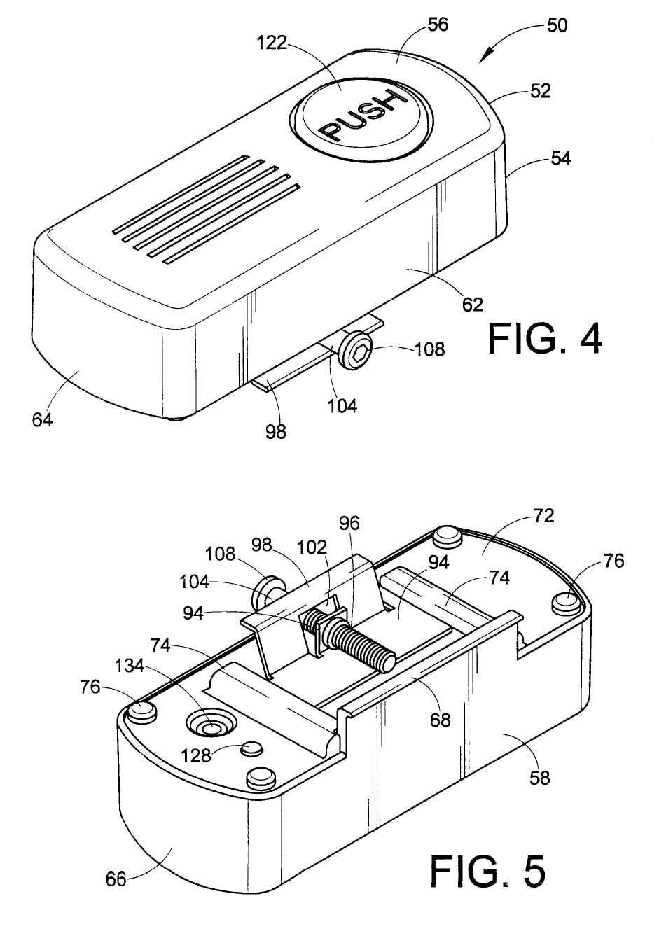

### DETAILED DESCRIPTION

With reference to FIG. 2, an audible product information device (“APID”) 50 is shown attached to a conventional label channel C located at a front edge of a retail shelf R. Such a typical lab channel C includes upper and lower grooves, respectively, that receive upper and lower edges of price labels that have the price for the item typically found above the corresponding label.

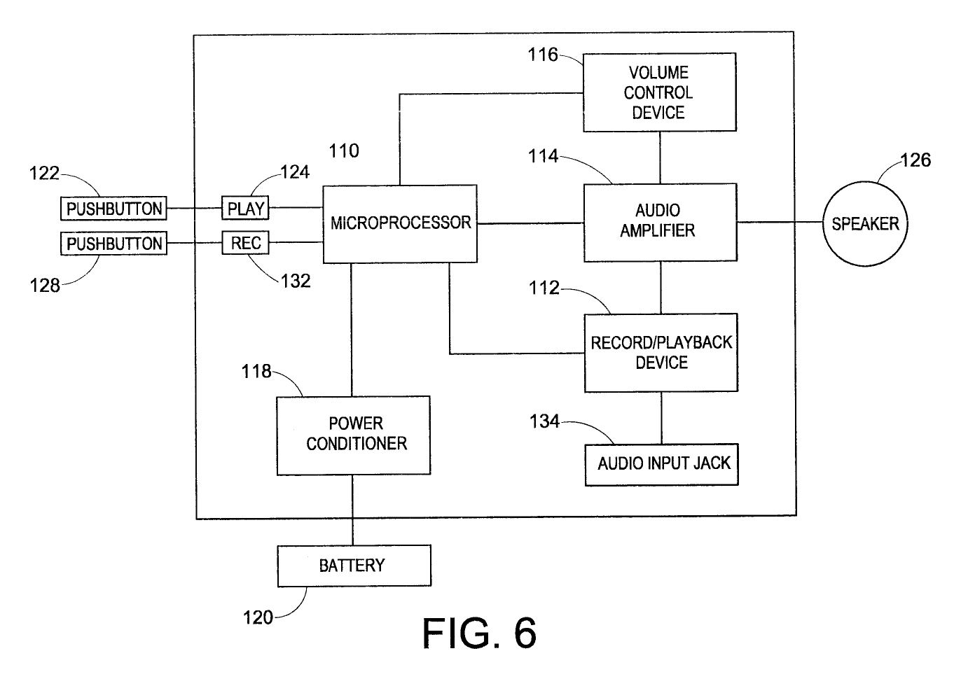

The APID 50 includes a housing 52 having a front housing portion 54 that defines a front face 56, a top 58, a bottom 62, a left side 64 and a right side 66. As more clearly seen FIGS. 3 and 6, the front housing portion 54 of the housing 52 also includes a mounting Flange 68 that extends rearward from the top 58 of the housing to allow the APID to easily mount to a conventional channel C. With reference to FIG. 3, a rear housing portion 72 (the rear housing portion could just as easily include the mounting flange 68) of the housing attaches to the front portion 54. The rear portion 72 defines a rear panel of the housing 52 and includes bracket flanges 74 that run generally vertically and are spaced horizontally from each other. Fasteners 76 are provided to attach the rear portion 72 of the housing to the front portion 54. Alternatively, the front portion 54 of the housing can attach to the rear portion 72 using a resilient tab and snap-type fit such as the type commonly used when attaching a plastic battery panel to a plastic housing.

With reference back to FIG. 2, the APID is shown mounted to the channel C located at front edge of the retail shelf R having a consumer product, which in this case is a bottle of wine W, disposed above and adjacent to the respective APID. With reference to FIG. 3, the APID 50 includes a mounting bracket assembly 90, which allows the APID to easily mount to the conventional channel C. With reference to FIG. 5, the mounting bracket assembly 90 includes a plate 92 that is trapped between the bracket flanges 74 on the rear panel 72 of the housing 52. As more easily seen in FIG. 5, the plate is formed to include a central flange 92 having a threaded opening 96. The plate 92 is also formed to include a lower flange 98 having a central opening 102 that is formed when the central flange 94 is formed. A fastener 94 is received through the larger opening 102 in the lower flange 98 and threadingly received in the threaded opening 96.

To mount the APID 50 to the channel C, the upper flange 68 is positioned in an upper groove of the label channel C and the fastener 104 is tightened so that its distal end 106 contacts the mounting flange 68 whereby additional tightening of the fastener 104 results in the lower flange 98 moving downwardly away from the upper flange 68. The lower flange 98 is then received inside a lower channel of the label channel C thereby mounting the APID to the conventional channel C. As more clearly seen in FIG. 2, when the APID 50 is attached to the channel C, the fastener 104 is typically not seen by the consumer. This provides some tamper resistivity for the APID in that the fastener 104 is not readily apparent to the consumer making the manner in which the APID attaches to the channel C not readily apparent to the consumer. Additionally, the head 108 of the fastener 104 can be configured to receive a special tool to further inhibit tampering and removal of the APID 50 from the channel C. Even though a particular mounting bracket assembly was described in particularity, the APID can attach to the channel C in other manners, for example, by using a spring loaded flange as opposed to the fastener that is used with the aforementioned assembly. Also, the rear panel 72 of the housing, which provides access to a battery compartment for the device, is positioned facing the channel C so that the APID must be removed from the channel to remove the rear panel. If desired, the bottom 62 of the front housing portion 54 could include a battery panel to provide access to a battery compartment. This arrangement would still keep the battery compartment access panel from being easily noticeable to a consumer who is activating the APID.

Because of the small dimensions of the housing 52 and the electrical components found in the housing, the APID easily attaches to the channel C so that the entire assembly is disposed forwardly, i.e. towards the consumer, of both the retail shelf R and a majority of the channel C, i.e. only the upper mounting flange 68 and the lower flange 98 are received in the respective upper and lower grooves of the channel. No separate battery compartment is required underneath the retail shelf because of the configuration of the electrical components of the device and that the device moves into a standby mode where the power draw for the electrical components of the device is lower than the self discharge rate of the battery found in the device (the self discharge rate being the rate in which the internal chemical reactions in the battery reduce the stored charge of the battery without any connection between the electrodes).

The height of the APID 50 is also small, typically less than about 1.75 inches (4.4 cm). As seen in FIG. 2, the top 58 of the housing 52 is generally aligned with or disposed beneath the upper edge of the channel C and support surface of the retail shelf R. By doing this, the product positioned above the APID is easily removable from the shelf without contacting in the APID. Additionally, the bottom 62 of the housing 52 is disposed above or aligned with the lower edge of the channel C thereby making removal of any product that is positioned below the APID easily accomplished without contacting the APID. The width of the APID, which is the horizontal dimension between the left side 64 and the right side 66 of the housing 52, is generally equal to a 375 ml bottle of wine (less than about 3 inches (7.5 cm)), where the APID is used in conjunction with wine. Nevertheless, the APID can take other configurations. The depth of APID 50, which is the dimension between the front face 54 and the rear panel 72 of the APID, is less than 2 inches (5 cm) and preferably less than 1 inch (2.5 cm). Such a small depth allows the APID to be easily mounted to the channel without having to accommodate large moment forces that could arise if the depth of the device was too great or if the device extended a greater distance from the channel C into the shopping aisle. Accordingly, an attractive, small and compact device is provided that can grab the consumer's attention more so than a conventional shelf talker card and can provide valuable educational information to the consumer regarding the product to which the APID is associated.

The APID 50 includes electrical components to allow the device to audibly display a product information message. With reference to FIG. 6, the APID includes a control, which in the depicted embodiment is a microprocessor 110, a record/playback device 112, an audio amplifier 114, a volume control device 116, a power conditioner 118 and a battery 120, which is found in a battery compartment within the housing 52. The APID operates in a record mode, a playback mode and a standby mode. Power from the battery is consumed while in the record mode and the playback mode, however, when the APID is in the standby mode, the power consumption of the electrical components of the device is less than the self discharge rate of the battery, which in the depicted embodiment is one standard AA alkaline battery.

The microprocessor 110 controls the operation of the APID by communicating with the record/playback device 112, the amplifier 114 and the volume control device 116. A first switch, designated as the play switch 124, is a momentary activation switch operated by a push button 122, which upon activation sends a signal to the microprocessor 110, which in turn communicates with the record/playback device 112, to deliver the product information message to a speaker 126 for playing an audible message to the consumer.

The record/playback device 112 in the depicted embodiment is a single chip configured for voice and audio recording and playback. Such a device is available from Winbond Electronics Corporation America. The record/playback device 112 includes a non-volatile message storage, or memory, that can record between about six seconds and about forty seconds of an audio message. The record/playback device 112 chosen in the depicted embodiment, as discussed above, is located on a single chip, but if desired, the recording device and the playback device can be located on different chips and/or different devices.

The amplifier 114 in the depicted embodiment is an audio power amplifier with DC volume control. The amplifier 114 receives the audible product information message from the record/playback device 112 and delivers an analog signal to the speaker 126 for playback upon activation of the push button 122. The speaker 126 in the depicted embodiment is enclosed in the housing 52.

The volume control device 116 provides the volume control for the APID. Such a device can include a digital potentiometer that communicates with the audio amplifier 114 to control the audio output from the amplifier. The volume control device 116 can be configured such that the push button 122, which is easily accessible by the consumer since it is positioned on the front panel 54 of the housing 52 (see FIG. 2), can through the play switch 124 operate the volume control device 116. Pressing and holding the play switch 124 for a predetermined amount of time can deliver a signal through the microprocessor 110 to the volume control device 116 to increase the volume setting up to a maximum threshold volume. The microprocessor 110 and the volume control device 116 can also be configured to cycle through to a lowest volume setting after the maximum threshold volume setting has been reached if the play switch 124 is still maintained in the closed position. If desired, the front panel 56 of the housing 52 can include instructions such as “press and hold for volume control” to provide the consumer instructions for increasing the volume of the message being displayed by the APID.

The power conditioner 118 conditions the power received from the battery 120 to deliver the desired voltage and current to the microprocessor 110. An example of such a power supply includes a high efficiency synchronous step up converter. The battery 120 is disposed in a battery compartment found in the housing 52 (FIG. 2) where the battery compartment includes electrical terminals that are in electrical communication with the power conditioner 118. The battery used in the depicted device is a single AA alkaline battery; however, a plurality of batteries and other conventional battery power sources can also be used if desired.

To load and/or record a message into the record/playback device 112, a record push button 128 (also seen in FIGS. 3 and 5) is depressed activating a record switch 132 which is in communication with the microprocessor 110. Activation of the record switch 132 wakes up the device from the standby mode and sends a signal to the record/playback device 112 to erase the previously saved audible product information device (when one is present on the record/playback device) and to begin a record mode for the device. An audio input jack 134 receives a cord that is connected to an external device to deliver the audio product information device through the audio input jack 134 and into the record/playback device 112. The record/playback device can receive analog signals so that the audio input jack can be the output from an external playback device including an MP3 player, a laptop computer, a cassette player, and the like. As more clearly seen in FIGS. 3 and 5, the push button 128 for operating the record switch 132 and the audio input jack 134 are located on the rear panel 72 of the housing 52. Typically, the APID is removed from the channel C (FIG. 2) prior to recording a new message on the APID. The push button 128 that activates the switch 132 and the audio input jack 134 are not accessible to the consumer unless the APID has been removed from the channel. If desired, the push button 128 and the audio input jack 134 can be moved to the bottom 62 of the housing where it would not be visible by a consumer who activates the playback button 122. Additionally, if the audio input jack 134 is reconfigured such that it could receive an RF or IR signal, it may be desirable to place the audio input elsewhere besides the rear panel 72

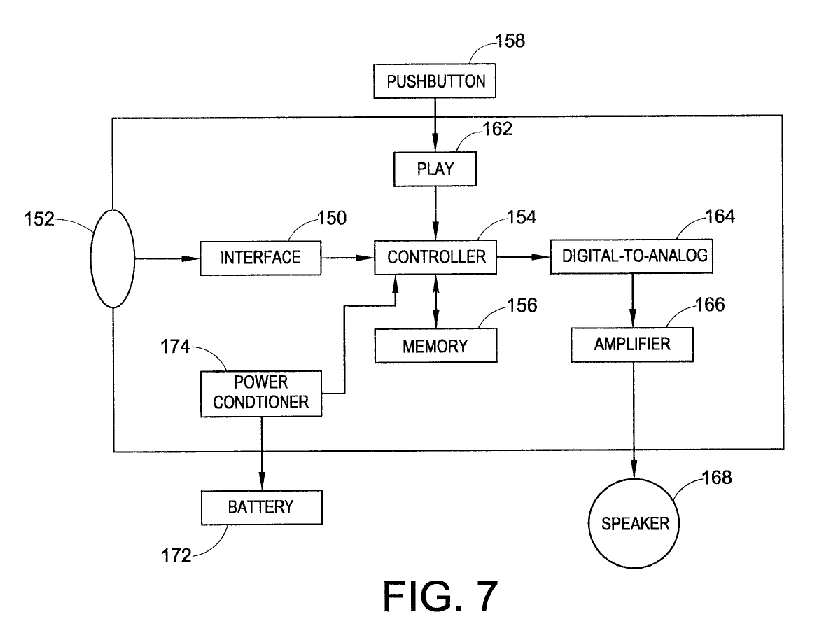

With reference to FIG. 7, an embodiment of an APID that stores digitally encoded informational messages in shown in schematic form. The APID in this embodiment would look identical to the consumer as the APID that was described above. Moreover, the bracket for attaching this APID to the front of a retail shelf would be the same. This APID, however, would include different interfaces for receiving an audible product information message that is to be displayed by the consumer.

With continued reference to FIG. 7, an interface 150, which can include a USB interface, an RF interface, and other known interfaces, is provided in the housing for receiving message input data from an input port 152. A controller, which can be similar to the microprocessor 110 described above, controls the operations of the APID and is in communication with a non-volatile memory 156 where it stores the incoming audible informational messages in digital form. When the controller 154 senses activation of a push button 158, which can be similar to the push button 122 described above, (in the depicted embodiment a switch 162 is provided between the push button 158 and the controller), the controller retrieves the audible information message data from the non-volatile memory 156 and sends the informational message to a digital-to-analog converter 164 for amplification by an amplifier 166 which outputs the audible informational message to a speaker 168, which can be similar to the speaker 126 described above. This embodiment of an APID can also be powered by a battery 172 operating through a power conditioner 174 in a similar manner to the APID described above.

Similar to the APID described in FIG. 6, the APID that includes the electrical components described in FIG. 7 can also operate in a record mode, a playback mode and a standby mode, and when in the standby mode the power draw of the electrical components is less than the self discharge rate of the battery found in the device. The record mode for the device can be entered by the interface 150 sensing that data is being sent through the port 152 or a button, similar to the record button described above, can be provided to wake up the device from a standby mode when a new message is to be recorded on the device.

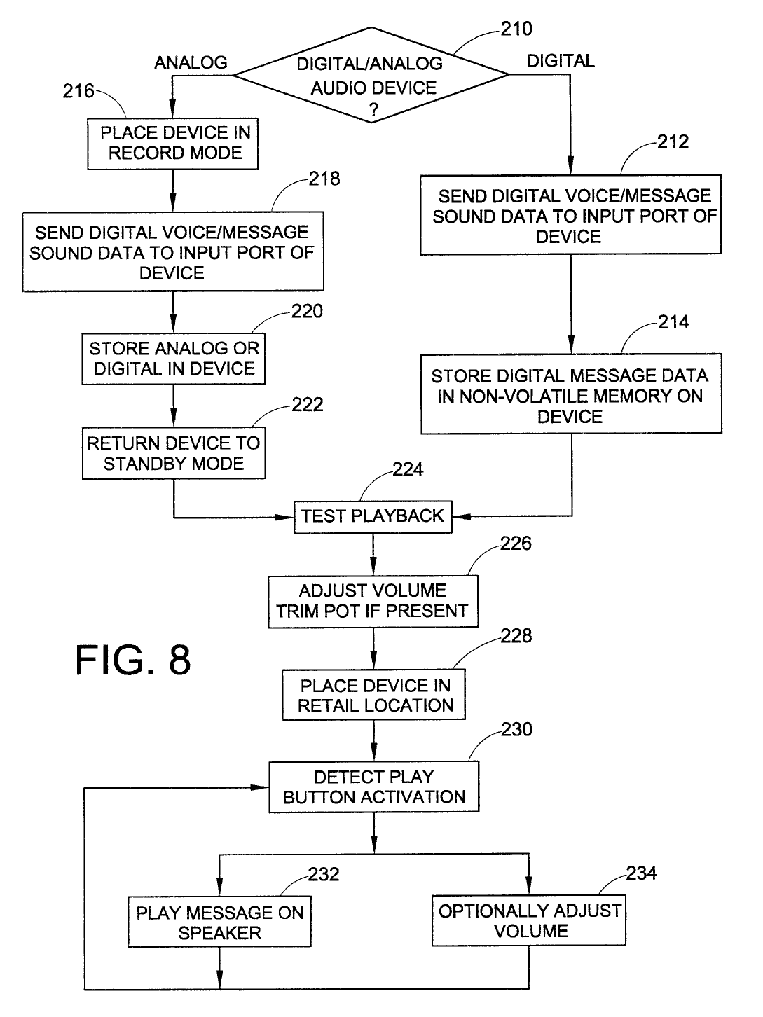

With reference to FIG. 8, a more detailed method of programming the APID and utilizing it for playback in a retail location is shown. The method of installing a recorded audio message on the APID differs slightly as determined at step 210 depending on whether the APID is a digital recording device or an analog recording device. In the case of a digital recording device, at step 212, digital voice message sound data from the recorded message is provided to the APID on the input port 152 (FIG. 7). As mentioned above, the input port 152 may be a network connection such as, for example, an Ethernet connection, and the product information messages may be received by means of a network from a remote computer. Similarly, the input port can be configured to receive a USB cord or the input port may be wireless to receive RF or IR signals. The APID can include mechanisms, such as circuitry and/or software, to inhibit unauthorized messages from being sent into and/or stored onto the memory of the APID. For example, the audible message that is received can include a stereo signal that includes the message that is to be displayed, e.g., heard, by the customer and an additional tone. If the additional tone is not detected, then the message will not be stored in the memory of the device. At step 214, the digital message data is stored in the non-volatile memory 156 (FIGURE 7) for future playback.

In the case of a analog IPID at step 216, the record/playback device 112 FIG. 6) is put into record mode by means of a signal, which can be provided via the record button 128 actuating the record switch 132 (FIG. 6) or by the audio input jack 134 (FIG. 6) receiving an audio cord. The analog message is then played or sent to the audio input jack 134 (FIG. 6) at step 218 and at step 220, the record/playback device 112 (FIG. 6) stores the analog data, or samples of the analog data, in an onboard memory of the record/playback device. Once a message has been installed or recorded on the APID, it is advisable to test the playback feature of the device as shown at step 224 and, if a volume potentiometer is provided on the circuit board, to adjust the volume to a desirable setting at step 226. At step 228 then, the APID can be affixed to its assigned location in the retail store if not already there. Therefore, when the APID detects activation of the playback button at step 230, the message is played back from the onboard memory to the speaker at step 232. Optionally, if an external volume control is provided, the customer may, at step 231, adjust the volume of the playback during the playback time.

An audible product information device and a method for providing an audible product message to a consumer has been described with reference to preferred embodiments. Directional terns, e.g. “right,” “left,” “rearward,” and the like, have been used for the convenience of the reader when describing the figures; these terms are not meant to limit the invention. The device and method have also been described with particular reference to the wine industry. The audible product information device and the methods for providing product information are amenable to other retail and/or consumer products. Modifications and alternations will occur to those reading and understanding the preceding detailed description. It is intended that the disclosed embodiments be construed as including all of the modifications and alterations insofar as they come within the scope of the appended claims or the equivalents thereof.

1. An audible product information device for placing proximate an associated consumer product, the device comprising:
a housing having a height that is less than or about equal to the height of a conventional label channel that is located at a front edge of a retail shelf and wherein the housing has a width that is less than or about equal to a greatest diameter of a conventional 750 mL bottle of wine;
a recording device in the housing for storing an audible product information message;
a playback device in the housing for playing the audible product information message;
a speaker for audibly outputting the audible product information message;
a battery compartment including terminals in electrical communication with the recording device and the playback device;
an activation switch for starting a playback of the product information message; and
a recording switch for controlling the delivery of power to the recording device.

2. The device of claim 1, wherein the recording device and the playback device each are found in a single chip.

3. The device of claim 2, wherein the single chip is configured to store an analog signal.

4. The device of claim 1, further comprising a mounting bracket connected to a rear portion of the housing, the bracket being configured connect with a conventional label channel that is located at a front edge of a retail shelf.

5. The device of claim 4, further comprising a first push button for activating the activation switch, the first push button being located on a front portion of the housing so that the first push button is easily accessible to a consumer.

6. The device of claim 5, further comprising a second push button for activating the recording switch, the second push button being located on or adjacent the rear portion of the housing so as not to be noticeable to a consumer who activates the first push button.

7. The device of claim 5, further comprising an input port located on or adjacent the rear portion of the housing so as not to be noticeable to a consumer who activates the first push button.

8. The device of claim 7, wherein the recording device is configured to receive the audible product information message as a digital signal.

9. The device of claim 7, wherein the recording device is configured to receive the audible product information message as an analog signal.

10. The device of claim 5, further comprising a removable battery panel on the housing for providing access to the battery compartment, the removable battery panel being located on or adjacent the rear portion of the housing so as not to be noticeable to a consumer who activates the first push button.

11. The device of claim 10, wherein the removable battery panel is arranged on the housing such that the removable battery panel is disposed in front of and generally parallel to the label channel that is located at a front edge of a retail shelf when the device is mounted to the label channel.

12. A method for providing product information to a consumer, the method comprising:
providing an audible product information device that is configured to mount to a retail shelf near a consumer product, the device comprising a housing, a memory in the housing, a control in the housing and in communication with the memory, an activation switch in communication with the control, a speaker in communication with the control, and a battery in the housing and in electrical communication with the control;
receiving an audible product information message into the memory of the audible product information device;
sensing operation of the activation switch in the audible product information device;
playing the product information message through the speaker when operation of the activation switch is sensed by the control circuit; and
shutting down the device after the playing the product information message so that power consumption of the audible product information device is less than the self discharge rate of the battery.

13. The method of claim 12, the providing further comprising providing a wake up switch for providing power to the control upon activation of the wake up switch and the receiving further comprising sensing operation of the wake up switch.

14. The method of claim 12, the receiving further comprising receiving a recorded analog audio message and inputting the received audio message into the memory.

15. The method of claim 12, further comprising attaching the audible product information device to a channel located at a front edge of a retail shelf such that a lower edge of the audible product information device does not extend below a lower edge of the channel.

16. The method of claim 12, further comprising attaching the audible product information device to a channel located at a front edge of a retail shelf, the providing further comprising providing a removable battery panel for providing access to the power source, and the attaching further comprising arranging the audible product information device so that the battery panel faces the channel and is inaccessible to the consumer when the audible product information device is attached to the channel.

17. The method of claim 12, further comprising attaching the audible product information device to a channel located at a front edge of a retail shelf, the providing further comprising providing an input port for receiving the audible product information message from an external device, and the attaching further comprising arranging the audible product information device so that the input port faces the channel and is inaccessible to the consumer when the audible product information device is attached to the channel.

18. The method of claim 12, further comprising attaching the audible product information device to a channel located at a front edge of a retail shelf, the providing further comprising providing the activation switch on a front panel of the audible product information device and providing an input port for receiving the audible product information message from an external device, and the attaching further comprising arranging the audible product information device so that the input port is not located on the front panel and is not visible to the consumer when the audible product information device is attached to the channel and the consumer is activating the activation switch.

19. An audible product information device for placing proximate an associated consumer product, the device comprising a housing, a controller, a record/playback device for storing and playing an audible product information message, a speaker for audibly outputting the audible product information message, battery contact terminals in electrical communication with the record/playback device, a play switch for starting a playback of the product information message, a recording switch for starting a recording of the product information message, and software on the controller to inhibit unauthorized messages from being sent into or stored on the record/playback device.

20. The device of claim 19, further comprising an input port, wherein the input port is configured to receive an RF or IR signal or is configured to receive a cord that is connected to an external device.
